(19) United States
(12) Patent Application Publication
(10) Pub. No.: US 2003/0131071 A1
(43) Pub. Date: Jul. 10, 2003

(54) Electronic document interchange document object model

(75) Inventors: Timothy E. Bennett, Brentwood, TN (US); R. David Moyers, Columbia, TN (US)

Correspondence Address: William T. Ellis, Foley & Lardner, Washington Harbour, 3000 K Street, N.W., Suite 500, Washington, DC, 20007-5143, US

(73) Assignee: G.E. INFORMATION SERVICES, INC.

(21) Appl. No.: 10/038,657

(22) Filed: Jan. 8, 2002

(51) Int. Cl. G06F 15/16

(52) U.S. Cl. 709/218

(57) ABSTRACT

A computer implemented method, apparatus and software for storing electronic document interchange (EDI) documents in a hierarchical manner in a memory, whereby the storing of data is performed independent of the type of format of the EDI document. Data is stored based on whether the data is segment data, transaction set data, functional group data, or attribute data, with linkages between these types of data as stored in the memory. That way, data can be retrieved from the memory according to a type of data that is desired to be retrieved.

### FIELD OF INVENTION

This invention relates generally to the field of analyzing and parsing electronic documents, and more particularly to a method, system and software for receiving and analyzing an Electronic Data Interchange (EDI) document by hierarchically representing the EDI document in a storage medium. The invention also provides a means for creating an EDI document using the hierachical constructs, and persisting the EDI document to a storage medium.

### BACKGROUND OF THE INVENTION

In current business practice, there is a need for data transfer between companies. The data transfer can be for a sale, an exchange, or any of the other various types of data transfers related to business transactions. For example, many purchase orders, invoices, and advance shipping notices are sent to and from trading partners over the course of a month or so, whereby these documents are transmitted and received by way of an EDI system provided at each trading partner.

EDI was developed to support business-to-business internal communication, and it has been around approximately for the last twentyfive years. However, EDI is also relevant for company-to-supplier retailer relationships, where the company can be an end-user, a manufacturer, a service organization such as a hospital or a hotel, a governmental organization or a virtual organization.

EDI can be viewed as a set of messages developed for business-to-business communication of electronic data. It works by providing a collection of standard message formats and element dictionaries for businesses to exchange data via any electronic messaging service, and is characterized by standardized electronic formats for exchanging business data. Thus, EDI is conveniently used in electronic commerce for the exchange of documents between trading partners in a transaction.

Companies sending and/or receiving EDI data are required to ensure that they have tailored software programs that map between two types of data, one being EDI data and the other being data in a company's internal system formats. Such mapping is a complex process that requires extensive resources and is time consuming.

The basic unit of information in an EDI document is a data element. An example of an EDI document is an invoice, a purchase order, or an advance shipping notice (ASN). Each item in the EDI invoice, purchase order or ASN is representative of a data element. Each data element may represent a singular fact, such as a price, product, model number, and so forth. A string of data elements can be grouped together, and is called a data segment, or segment. There can be several data segments per document or message, each having its own use. Each data segment is used for defining a specific item. In addition, an EDI document may include functional groups and transaction sets. Furthermore, an EDI document generally includes addressing information specific to a trading partner.

Translators are used to provide the mapping necessary to read EDI documents. Translators read and parse documents in an EDI format, to generate visual documents for data entry, to translate the EDI to an in-house format, or to change statuses of the data within an application itself.

An EDI interchange is read from a flat file, and then serially processed by a translator. The interchange is the “envelope” by which one or more electronic documents are carried as they traverse the EDI from one company to another company. For conventional EDI systems, there is no convenient way to hierarchically represent an EDI interchange or an EDI document in a model, so as to allow third party applications to traverse, fetch, and/or set specific segment, element or sub-element data within an EDI interchange or an EDI document. Furthermore, there is no convenient way to allow a user to persist the data once a particular operation has been performed on an EDI interchange or an EDI document.

### SUMMARY OF THE INVENTION

According to an aspect of one embodiment of the present invention, there is provided a computer implemented method of automatically generating Electronic Data Interchange (EDI) documents or messages using an EDI system. The method includes a step of extracting segment information, transaction set information, functional group information, and attribute information from an EDI document. The method also includes a step of storing the extracted information in a memory in a hierarchical manner according to whether the extracted information is the segment information, the transaction set information, and the attribute information.

According to an aspect of another embodiment of the present invention, there is provided a system for automatically generating data in a self-describing markup language format from received EDI data. The system includes a data extractor that is configured to extract segment information, transaction set information, functional group information, and attribute information from an EDI document. The system also includes a memory that is configured to store the extracted information in a hierarchical manner, the extracted information being stored in the memory in accordance to whether the extracted information is the segment information, the transaction set information, and the attribute information.

According to an aspect of yet another embodiment of the present invention, there is provided a computer readable data storage medium for an EDI system having program code recorded thereon that is executable by a computer. The program codes performs a step of extracting segment information, transaction set information, functional group information, and attribute information from an EDI document. The program code also performs a step of storing the extracted information in a memory in a hierarchical manner according to whether the extracted information is the segment information, the transaction set information, and the attribute information.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a block diagram showing the general components of a computer system that can be used to run an EDI DOM according to an embodiment of the present invention;

FIG. 2 is a block diagram showing a hierarchical memory representation of an EDI document that is provided by way of an EDI DOM according to an embodiment of the present invention;

FIG. 3 is a sequence of steps that a user may perform in order to retrieve certain data from an EDI document stored by way of an EDI DOM according to an embodiment of the present invention;

FIG. 4 is an example of an EDI interchange that can be input to a system having an EDI DOM according to an embodiment of the present invention;

FIG. 5A shows a portion of the EDI interchange of FIG. 4 corresponding to a first invoice;

FIG. 5B shows a portion of the EDI interchange of FIG. 4 corresponding to an invoice entity;

FIG. 6 is an example of VB script that can be used to access a document stored in the EDI DOM according to an embodiment of the present invention;

FIG. 7 shows an invoice template that has been populated with data obtained from modules of the EDI DOM according to an embodiment of the present invention; and

FIG. 8 shows an annotated example of an EDI document and how each entity of the document is hierarchically stored in the EDI DOM according to an embodiment of the invention.

### DETAILED DESCRIPTION OF THE PREFERRED EMBODIMENTS

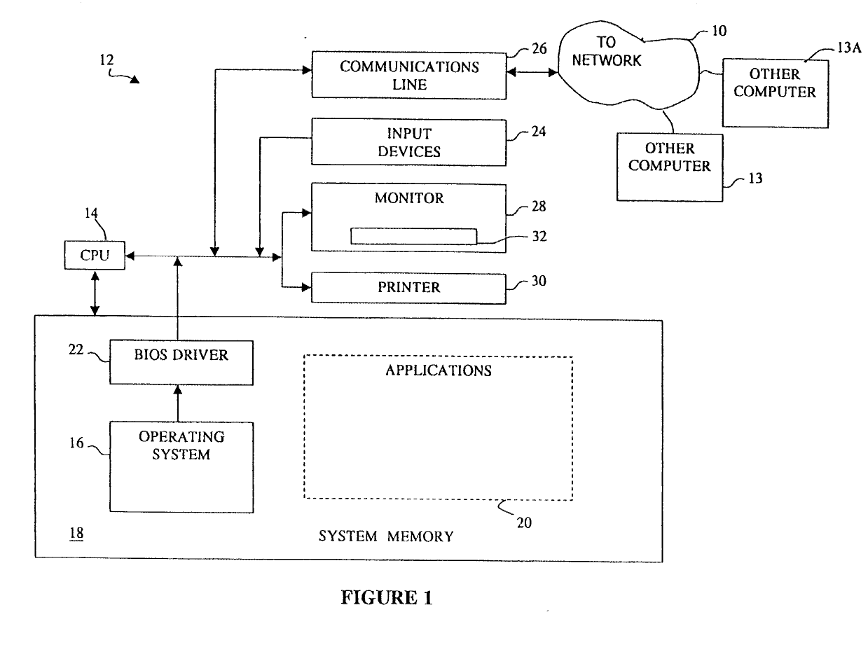

With reference to the accompanying drawings, a detailed description of the present invention will be provided. FIG. 1 is a block diagram showing the components of a general purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network (VPN). As shown in FIG. 1, the computer system 12 includes a central processing unit (CPU) 14 connected to a system memory 18. The system memory 18 typically contains an operating system 16, a BIOS (basic input/output system) driver 22, and application programs 20. In addition, the computer system 12 contains input devices 24 such as a mouse and a keyboard 32, and output devices such as a printer 30 and a display monitor 28.

The computer system generally includes a communications interface 26, such as an Ethernet card, to communicate to the electronic network 10. Other computer systems 13 and 13A may also be connected to the electronic network 10. One skilled in the art would recognize that the above system describes the typical components of a computer system connected to an electronic network. It should be appreciated that many other similar configurations are within the abilities of one skilled in the art and all of these configurations could be used with the methods of the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, “electronic” networks are generically used to refer to the communications network connecting the processing sites of the present invention, including implementation by using optical or other equivalent technologies.

One skilled in the art would recognize that other system configurations and data structures and electronic/data signals could be provided to implement the functionality of the present invention. All such configurations and data structures are considered to be within the scope of the present invention.

The present invention is directed to an EDI Document Object Model, or EDI DOM, (hereinafter also referred to as “model”), which allows for an electronic interchange or document to be represented as an in-memory hierarchical model. With such a model, various types of client software and applications can be utilized in order to manipulate, extract, and set segment, element, and/or sub-element information stored within the model. This allows one to readily generate an ANSI, EDIFACT, or TRADACOMS interchange or document from the model. That is, a user is able to parse and pull particular information from a first electronic document, whereby that information may correspond to segment data, element data or sub-element data, and pull that information into a second electronic document in the same EDI format or in another EDI format. By way of example and not by way of limitation, a user can readily create an EDI Invoice that is formatted in accordance with an ANSI X12 standard, based on information obtained from a received EDI Purchase Order that is formatted in accordance with an UN EDIFACT standard. The EDI DOM introspects the data during the parsing and determines the type of standard used (e.g. ANSI, EDIFACT, TRADACOMS), and after that determination is made, information pertinent to the proper parsing of the document (e.g. element separators, segment terminators, looping constructs, etc.) is subsequently discerned. Upon this discernment, the EDI DOM correctly parses and hierarchically represents the EDI document to allow programmatic access to the data.

In one embodiment, the EDI DOM exists as a Java-based component (e.g., software program) in a computer system. The EDI DOM is capable of reading an interchange or document from a flat file or from a database. From the information that has been read, the EDI DOM represents the interchange or document in a hierarchical model, and allows a calling application to traverse the hierarchically-stored data.

By having a Java-based component for implementation of the EDI DOM, the EDI DOM can exist on different computer platforms that may have different operating systems (e.g., UNIX, OS/2, LINUX, WINDOWS). The EDI DOM can be obtained by downloading the Java-based component from a server, for example. That way, one does not have to rewrite it, deport it, or recompile it. In this regard, the EDI DOM is platform independent.

As explained above, the EDI DOM provides for an electronic interchange or document to be represented in memory by a calling application, for example, by an application using Microsoft EXCEL™, POWER POINT™, or WORD™. By using application software such as Visual Basic, for example, a user can create procedures to traverse the EDI DOM to obtain only the information that the user needs, in a fast, efficient process. Moreover, the application software can be used to set specific elements or sub-elements in the interchange or document, whereby the updated interchange or document can be persisted back out to disk or to some other storage medium. Use of the EDI DOM according to the present invention provides for considerable integration and automation capabilities with EDI data.

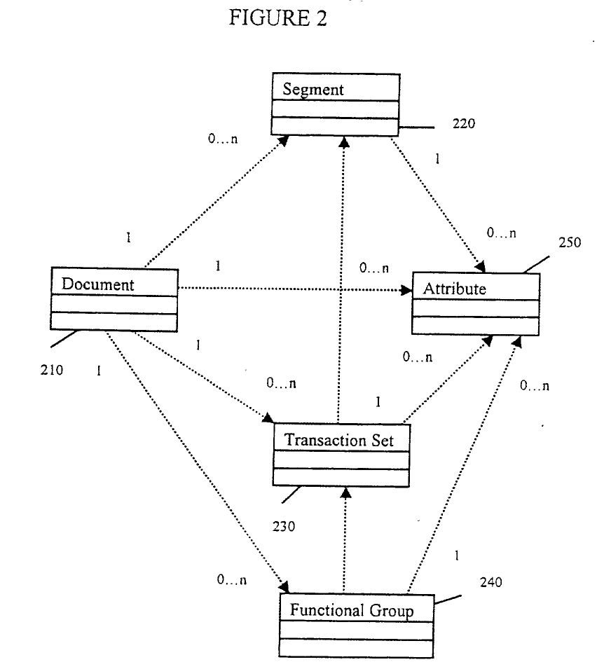

A detailed description of the Document Object Model according to an embodiment of the present invention will now be explained with reference to FIG. 2.

The EDI DOM contains the classes or objects that serve as a container for EDI document elements. The EDI DOM provides a generic, in-memory representation of an EDI document, thereby allowing the same model to describe and parse ANSI, EDIFACT and/or TRADACOMS documents. The overall object model is shown in FIG. 2, and includes a Document class (or object), a Segment class (or object), a Functional Group class (or object), a Transaction Set class (or object), and an Attribute class (or object).

EDI documents are represented as a collection of attributes, segments, functional groups and transaction sets. The EDI DOM according to the present invention takes advantage of this type of representation, and stores that information as objects in a hierarchical manner in a memory, to allow specific data to be retrieved from an electronic document according to those representations.

By utilizing EDI-specific representations, information from an electronic document can be retrieved irrespective as to the specific format that it is in. Thus, functional group information from an ANSI X12 document can be retrieved in a same manner as it would be retrieved from an EDIFACT document, by using the EDI DOM according to an embodiment of the invention. Since the TRADACOMS format does not have functional groups, the data would be represented in the EDI DOM as a series of Transaction Sets.

Referring now to FIG. 2, the Document class 210 represents an EDI document as a collection of attributes, segments, functional groups, and transaction sets. The Document class 210 is the root node of the DOM-style representation of an EDI document according to the invention, whereby a document is represented in the EDI DOM as a collection of the fundamental entities of the document.

The fundamental entities of an EDI document, which is represented by a Document node 210 in FIG. 2, are: 1) a single interchange envelope by which the EDI document is sent from one company to another company; 2) zero or more interchange control segments, as indicated by zero or more interchange control segment nodes 220; 3) zero or more transaction sets contained within a functional group, as indicated by zero or more transaction set nodes 230; and 4) zero or more functional groups containing one or more transaction sets, as indicated by zero or more functional group nodes 240. The data for each node is stored in memory, whereby data for a node can be retrieved from the memory in a manner known to those skilled in the art with respect to memory data retrieval. Transaction set nodes can occur in an EDI document apart from their inclusion in a functional group. In other words, hierarchically speaking, an EDI document can contain zero or more “independent” transaction sets plus zero or more functional groups, which contain one or more transaction sets.

In the present invention, data of an EDI document is stored according to the hierarchical model shown in FIG. 2, with mappings between the nodes in the model as shown. Each of the four classes or nodes contains a header that includes one or more data elements, which are represented by a collection of attributes (which are implemented as name-value pairs), whereby the attributes are stored in accordance with the attribute node 250 in FIG. 2.

For example, the header for the document node 210 may have a plurality of attributes, as shown by the 0-to-n mapping between the document node 210 and the attribute node 250.

In a conventional EDI electronic document, the document entity, the segment entity or entities, the transaction set entity or entities, and the functional group entity or entities are stored in a sequential manner in the electronic document. Headers are provided between these entities in the electronic document to provide delimiters for the different entities of the electronic document, as well as to provide attribute information that is related to the type of information stored for each entity. One important feature of the EDI DOM according to an embodiment of the invention is that it gives a user random access to an EDI document, as opposed to the conventional methods of sequential access.

The segment class 220 represents a segment of an EDI document as a collection of attributes. The segment class 220 is part of the DOM-style representation of an EDI document, and represents an individual segment of an EDI document as a collection of attribute objects. This is seen by the 0-to-n mapping between the segment class 220 and the attribute class 250.

The transaction set class 230 represents an encoded business transaction set. The transaction set class 230 is part of the DOM-style representation of an EDI document, and represents individual transaction sets as a collection of segment objects that comprise the encoded business transaction, along with a collection of attribute objects. The attributes represent the name and value of a data element within each segment of the transaction set. FIG. 2 shows a 0-to-n mapping between the transaction set class 230 and the segment class 220, and a 0-to-n mapping between the transaction set class 230 and the attribute class 250.

By way of example and not by way of limitation, a transaction set class may correspond to a “purchase order” class, whereby the quantity of components and the type of components in the purchase order document are encoded in a specific format, according to the specific transaction set class.

The functional group class 240 represents a functional group of an EDI document as a collection of attributes and transaction sets. The functional group class 240 is part of the DOM-style representation of an EDI document, and represents individual functional groups of an EDI document as a collection of embedded transaction set objects, along with a collection of attributes that represent the data elements in the header and trailer or the functional group. FIG. 2 shows a 0-to-n mapping between the functional group class 240 and the transaction set class 230, and a 0-to-n mapping between the functional group class 240 and the attribute class 250.

For EDI documents, functional groups are provided for grouping common transaction sets within an EDI interchange. For example, a functional group for invoices would be present separate from other functional groups provided for advance shipping notices or acknowledgements.

By using the EDI DOM according to an embodiment the present invention, an EDI document is represented and stored in a memory according to a logical hierarchy, so as to genericize the EDI document to be parsed according to different EDI standards, such as by using ANSI, EDIFACT, or TRADACOMS, for example.

Therefore, according to a particular object or class, one can obtain any desired information from an EDI interchange or document, such as all of the functional groups or a particular transaction set in an interchange or document. Based on that information, one can then parse the data of one EDI document and persist it to another document that can be created by using the EDI DOM according to an embodiment of the invention.

Also, since the EDI DOM is independent of any particular EDI document standard, no matter what type of electronic document is being received by the system, that is, whether it is an ANSI-formatted document, an EDIFACT-formatted document, etc., the EDI DOM parses the document and stores data in a hierarchical manner according to the groups/classes described above, since this data hierarchy is essentially common to the ANSI, EDIFACT and TRADACOMS EDI standards.

By way of the EDI DOM according to the present invention, a user can parse through an electronic document received by way of the EDI system, and retrieve information from it irrespective as to the type of format that the electronic document was created. This is because all of the standard EDI formats have the same common hierarchical structure, which is the way by which data from an EDI document is stored in a memory that is accessed by way of the EDI DOM.

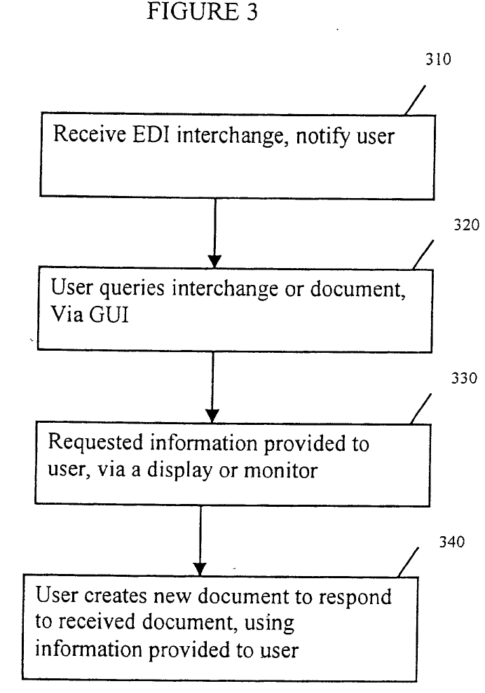

Referring now to FIG. 3, when an interchange or document is received by the EDI DOM, a user is prompted or notified, as shown by step 310. The user then can access information in the just-received interchange or document by sending a query to the EDI DOM, as shown by step 320. A standard graphical user interface can be used to perform this function between the EDI DOM and the user. For example, the user could send a request to the EDI DOM for all segments greater than a particular length to be retrieved from the just-received interchange or document.

The EDI DOM responds to the request by accessing stored information of the just-received document in accordance with the hierarchy of classes and objects as shown in FIG. 2. For example, all segments meeting the user's request, and all the attribute information corresponding to those segments, is retrieved from memory based on the relationships shown in FIG. 2. The requested information is provided to the user on a monitor or other type of display, as shown by step 330. The user can then use that information to populate another EDI document that the user can create so as to “respond” to the received document, as shown by step 340.

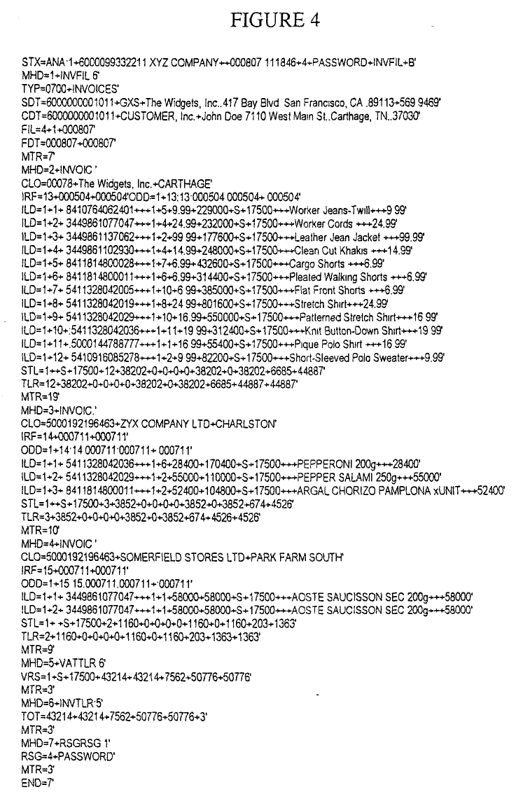

Referring now to FIGS. 4-7, an explanation will now be given of an interaction between a client application and the EDI DOM according to an embodiment of the invention. In the example used to provide this explanation, the client application is Microsoft EXCEL™, but of course any client application for creating of modifying documents or messages may be utilized while remaining within the scope of the invention.

This example describes how the EDI DOM is used to populate an invoice template within Microsoft EXCEL™. This example illustrates a simple use case of the EDI DOM, and one of ordinary skill in the art will recognize that more complex and involved cases can be envisioned with the EDI DOM.

The invoice template in this example is an EXCEL™ worksheet with embedded Visual Basic (VB) scripting. The VB scripting interacts with the EDI DOM modules to:

a) read an EDI interchange (a TRADACOMS EDI interchange in this example) containing at least one EDI invoice template (two EDI invoice transactions in this example) from memory or from disk, and dynamically populate the invoice template within EXCEL™, and

b) persist (save) the data within the EXCEL™-based invoice template into an (TRADACOMS in this example) EDI interchange.

FIG. 4 shows an example of a TRADACOMS EDI interchange used in this example. Of course, other types of EDI interchange documents, such as UN EDIFACT or ANSI X12, may be used instead of TRADACOMS.

The TRADACOMS EDI interchange shown in FIG. 4 includes two (2) separate invoices. In this example, the EDI DOM according to the invention is used to parse information regarding the first invoice only. Of course, it can be used to parse information regarding the second invoice only, or it can be used to parse information from both invoices, depending on what the user wants to do.

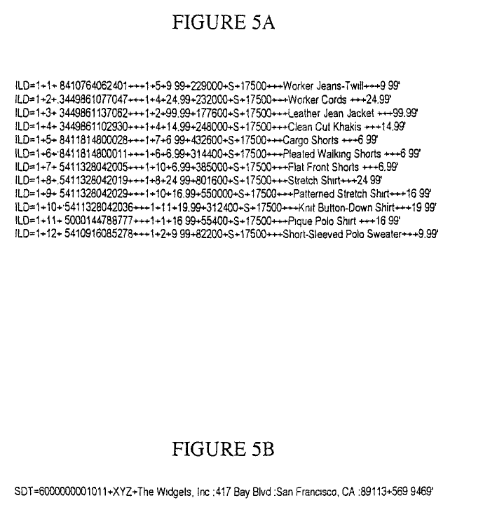

The invoice line items corresponding to the first invoice are represented in the EDI interchange of FIG. 4 by the line items shown in FIG. 5A.

The invoicing entity of the first invoice is represented in the EDI interchange of FIG. 4 by the line item shown in FIG. 5B. The information shown in FIG. 5A and FIG. 5B is extracted from the EDI interchange of FIG. 4 and placed into the various hierarchical modules of the EDI DOM of FIG. 2, based on information obtained from the EDI interchange (e.g., is it a TRADACOMS, ANSI or EDIFACT document) by the EDI DOM.

In this example, not all information from the invoice and its lines items are used to populate the EXCEL™ invoice template, but rather only the pertinent information is used and hence displayed to the user.

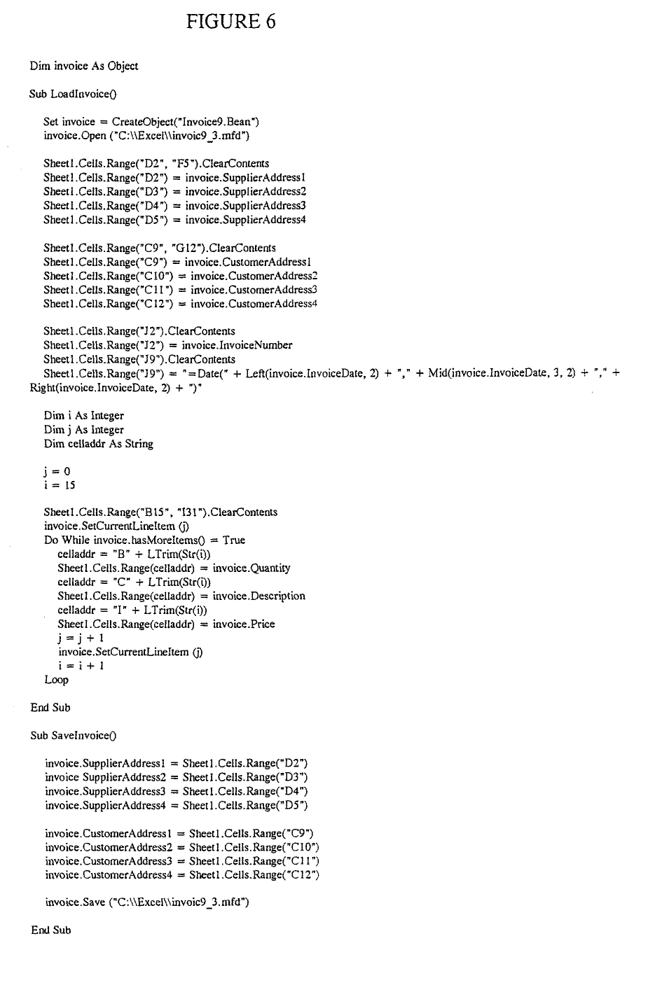

The client application interaction with the EDI DOM in this example will now be described. The EXCEL™ worksheet invoice template has embedded VB script to use the EDI DOM application-programming interface (API) to parse the EDI document that has been stored in a hierarchical manner in memory by the EDI DOM. An example of VB script that can be used to parse the EDI document, and which illustrates the interaction with the EDI DOM to populate the EXCEL™ invoice template, is provided in FIG. 6.

The VB script routine shown in FIG. 6 provides for:

a) loading the EDI interchange data from a flat file and populating the EXCEL™ invoice template (e.g., LoadInvoice( )), and

b) saving the data as an EDI interchange into a flat file (e.g., SaveInvoice( )).

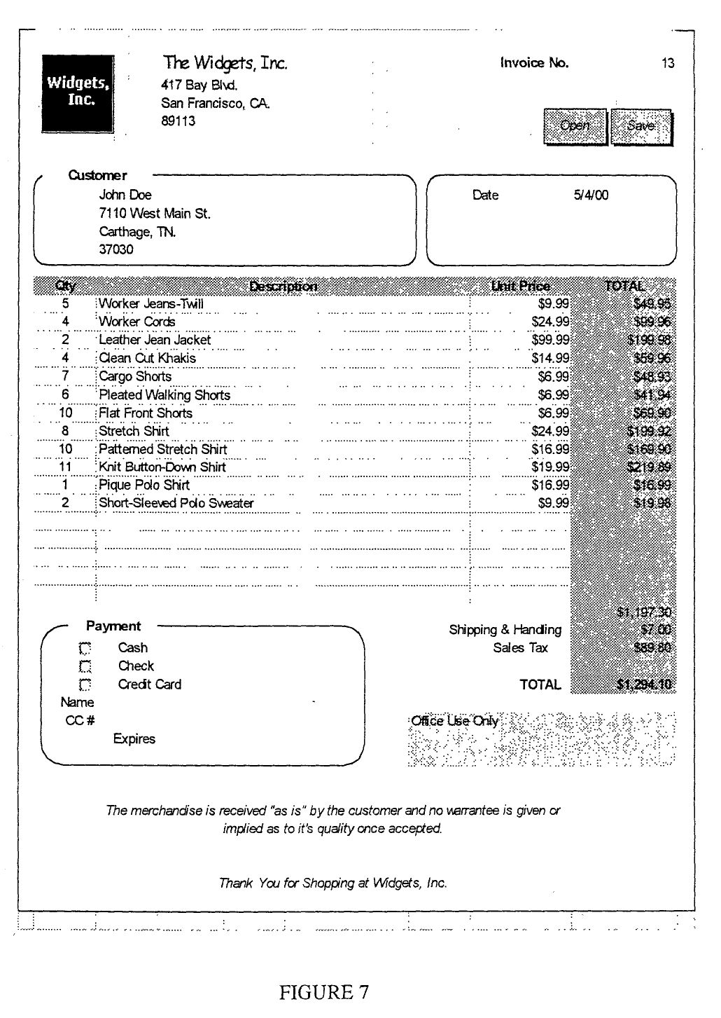

Upon loading the invoice template worksheet within EXCEL™ the end-user clicks on “OPEN” (see FIG. 7) on the display to read the EDI data and to populate the invoice template from the EDI interchange. The screen print provided in FIG. 7 illustrates an invoice that has been populated from the EDI interchange of FIG. 4, which has been stored in a hierarchical manner in memory by the EDI DOM according to the invention. As can be seen in FIG. 7, an invoice can be readily created from an EDI interchange, by using the EDI DOM according to the invention.

The end-user may then click on “SAVE” (see FIG. 7) on the display of the invoice, in order to persist the data to disk in EDI format, if desired.

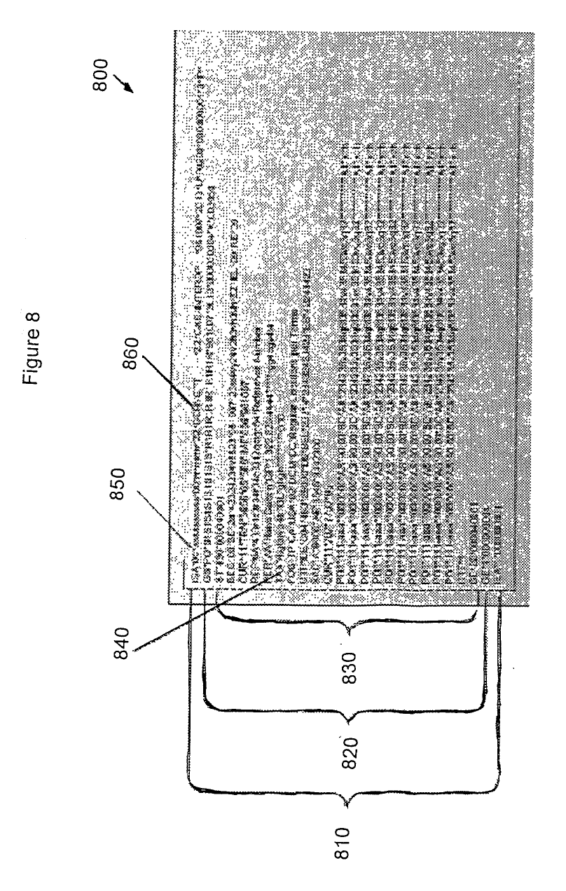

FIG. 8 is an annotated example of an EDI ANSI X-12 document 800. FIG. 8 includes callouts that annotate how each entity of the EDI document is stored in the EDI DOM according to an embodiment of the invention. The EDI document shown in FIG. 8 includes: a) a single interchange 810, b) zero “independent” transaction sets, and c) a single functional group 820 containing a single transaction set 830. This data is stored in a hierarchical manner in the EDI DOM, to allow for random access of any particular portion of the EDI document, by a user of the EDI DOM.

Label 840 in FIG. 8 shows an example of a data segment, which is typical of each line of an EDI document. Label 850 in FIG. 9 shows a data field separator, which is typical throughout the EDI document. Label 860 shows an example of a data field shared in the EDI DOM as an attribute, which is typical throughout the EDI document.

Other embodiments of the invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A computer implemented method of automatically generating Electronic Data Interchange (EDI) documents or messages using an EDI system, comprising:
extracting segments, transaction sets, functional groups, and attributes from an EDI document, as extracted data; and
storing the extracted data in a memory in a hierarchical manner according to whether the extracted data is segment data, transaction set data, functional group data, or attribute data.

2. The method according to claim 1, further comprising:
extracting at least one segment from the EDI document from the memory based on a hierarchical relationship between the segment and other data of the EDI document stored in the memory.

3. The method according to claim 1, further comprising:
extracting at least one transaction set from the EDI document from the memory based on a hierarchical relationship between the segment and other data of the EDI document stored in the memory.

4. The method according to claim 1, further comprising:
extracting at least one functional group from the EDI document from the memory based on a hierarchical relationship between the segment and other data of the EDI document stored in the memory.

5. The method according to claim 1, further comprising:
extracting at least one functional group from the EDI document from the memory based on a hierarchical relationship between the segment and other data of the EDI document stored in the memory; and
extracting at least one transaction set from the EDI document that is a part of the at least one functional group, based on a linkage in the memory of the at least one transaction set to the at least one functional group.

6. A system for automatically generating data in a self-describing markup language format from received EDI data, comprising:
a data extractor that is configured to extract segments, transaction sets, functional groups, and attributes from an EDI document, as extracted data; and
a memory that is configured to store the extracted data in a hierarchical manner, the extracted data being stored in the memory according to whether the extracted data is segment data, transaction set data, functional group data, or attribute data.

7. The system according to claim 6, further comprising:
a second data extractor that extracts at least one segment from the EDI document from the memory based on a hierarchical relationship between the segment and other data of the EDI document stored in the memory.

8. The system according to claim 6, further comprising:
a second data extractor that extracts at least one transaction set from the EDI document from the memory based on a hierarchical relationship between the segment and other data of the EDI document stored in the memory.

9. The system according to claim 6, further comprising:
a second data extractor that extracts at least one functional group from the EDI document from the memory based on a hierarchical relationship between the segment and other data of the EDI document stored in the memory.

10. The system according to claim 6, further comprising:
a second data extractor that extracts at least one functional group from the EDI document from the memory based on a hierarchical relationship between the segment and other data of the EDI document stored in the memory; and
a third data extractor that extracts at least one transaction set from the EDI document that is a part of the at least one functional group, based on a linkage in the memory of the at least one transaction set to the at least one functional group.

11. A computer readable data storage medium for an EDI system having program code recorded thereon that is executable by a computer to perform the following steps:
extracting segments, transaction sets, functional groups, and attributes from an EDI document, as extracted data; and
storing the extracted data in a memory in a hierarchical manner according to whether the extracted data is segment data, transaction set data, functional group data, or attribute data.

12. The computer readable data storage medium having program code recorded thereon according to claim 11, further comprising:
extracting at least one segment from the EDI document from the memory based on a hierarchical relationship between the segment and other data of the EDI document stored in the memory.

13. The computer readable data storage medium having program code recorded thereon according to claim 11, further comprising:
extracting at least one transaction set from the EDI document from the memory based on a hierarchical relationship between the segment and other data of the EDI document stored in the memory.

14. The computer readable data storage medium having program code recorded thereon according to claim 11, further comprising:
extracting at least one functional group from the EDI document from the memory based on a hierarchical relationship between the segment and other data of the EDI document stored in the memory.

15. The computer readable data storage medium having program code recorded thereon according to claim 11, further comprising:
extracting at least one functional group from the EDI document from the memory based on a hierarchical relationship between the segment and other data of the EDI document stored in the memory; and
extracting at least one transaction set from the EDI document that is a part of the at least one functional group, based on a linkage in the memory of the at least one transaction set to the at least one functional group.
